(19) United States
(12) Patent Application Publication
(10) Pub. No.: US 2019/0018656 A1
(43) Pub. Date: Jan. 17, 2019

(54) PLATFORM FOR THIRD PARTY AUGMENTED REALITY EXPERIENCES

(71) Applicant: Monsarrat, Inc., Cambridge, MA (US)

(72) Inventor: Jonathan Monsarrat, Cambridge, MA (US)

(21) Appl. No.: 15/975,673

(22) Filed: May 9, 2018

Related U.S. Application Data
(60) Provisional application No. 62/505,440, filed on May 12, 2017.

(51) Int. Cl. G06F 8/33; G06F 8/77; G06Q 30/06; G06T 19/00; H04L 29/08

(52) U.S. Cl. CPC G06F 8/33; G06F 8/77; H04L 67/1002; G06T 19/006; G06Q 30/0641

(57) ABSTRACT

A data processing system and method that permits third party applications to run in a single, persistent augmented reality environment.

### CROSS REFERENCE TO RELATED APPLICATIONS

This application claims priority to U.S. Provisional Application Ser. No. 62/505,440 filed May 12, 2017, the entire contents of which are hereby incorporated by reference.

### BACKGROUND

Although many companies offer an augmented reality (AR) software development toolkit (SDK), these software libraries only sense the position of the user's mobile device and display graphical content. These SDKs are only useful to easily build trivial applications for a single user in a single location. It's too expensive and time-consuming to build all the software that would host a community of users. It's too expensive and time-consuming to build a persistent shared world filled with content that users can see by moving through the real world.

This limits the potential of many good potential AR applications. For example, a developer may want to build an AR Wizard of Oz world for thousands of players that is spread out across an entire city. AR SDKs can show simple content, but developers are left on their own to:
Build AR-adapted content like the Munchkins who sense users and dance around them,
Host content in the cloud in a way that is optimal for AR experiences,
Integrate maps into the AR experience, so when you want to follow the Yellow Brick Road in the game, you know where to go in the real world,
Build a community with anonymous messages and real world meet-ups,
Allow users to pay or get paid for AR experiences, and
Measure and analyze user and AR experience metrics.

A platform would help. A “platform” is a set of shared functionality that is provided to apps so that developers don't need to code everything from scratch. This reduces time and cost to build those apps. A platform is needed for third party AR experience developers.

Each of these apps could run in a single shared environment, so that users could easily switch between them, and so that all apps would potentially have access to all users. You would launch the platform, choose your AR experience, and see it all around you through your mobile device.

### SUMMARY

Briefly, the techniques described herein assumes an augmented reality SDK that provides location sensing for a mobile device and graphical display. As in FIG. 1, the platform then adds several new features:
A content builder (FIG. 2) allows AR app developers to import contact and describe its behavior with scripted event triggers and behaviors,
An app distribution process (FIG. 4) allows developers to submit an app for vetting, offer it to users, and receive ratings and reviews,
Users see what apps are available (FIG. 4) and may download and try one,
A cloud-based hosting system (FIG. 4) serves up content, executes interactivity scripts, and handles interactivity between users and AR items, AR characters, and other users,
A user community (FIG. 4) can communicate and meet with each other anonymously, and submit ratings and reviews on apps,
A mapping system (FIG. 3) allows developers to describe map locations by scripted “descriptors”, and then to plan routes for AR characters and users along routes that use these map descriptors,
App performance metrics and user performance metrics are calculated and presented to app developers, and
Developers may call upon built-in revenue model channels for users to make and receive payments in the AR experience.

To begin developing an AR app, a developer imports content such as 3D models into the AR content builder. Then the developer writes code in an AR interactivity scripting language to configure how AR items and AR characters behave.

The developer then submits the app for vetting, and the app goes live for users to select. Users may browser events on an app store by keyword, topic, or popularity, or may discover app content that is pinned to map locations on a map that the user browses.

Users may belong to a single shared community that can search, download, and install an app from a ‘store’ of AR applications. After opening the app, a user is then presented with nearby AR items and characters, which have event listeners. When an event listener is triggered, the AR item or character executes a script and performs the specified actions, if any.

User and app performance metrics are collected, and load balancing and redistribution of the servers may be triggered. App updates may be automatically distributed to users.

Users may rate and review the apps. Users may anonymously communicate with or meet with other users. Users may have an “inventory” that represents owned AR items.

The challenges are then:
a) What is the best way for app developers to code AR-specific item and character behaviors?
b) What types of environmental changes could be sensed and trigger script events?
c) What types of behavior should AR characters be capable of?
d) What is the best way for developers to refer to map locations in the real world?
e) What is the best way for map routes to be computed?
f) What is the best way for users to interact anonymously?
g) What are the best types of metrics and how are they computed?

These problems are solved with a method according to a preferred embodiment in the following way:
a) App developers can code AR item and character behaviors using a scripting system that:
   allows high-level sensors that trigger script events
   allows high-level behaviors to be performed
   ties into user communication, mapping, and revenue model functions
b) Event listeners could be triggered by:
   updates to the location or orientation of users, AR items, or AR characters,
   user-initiated interactions,
   high-level sensor definitions built upon the above and user and map metadata
c) Scripted behaviors for AR characters and items can be defined as step-by-step functions that include moving along a map route, interacting with users, and interacting with AR items and other AR characters. Basic behaviors may then be assembled into larger and more complex behaviors. Scripted sensors allow AR characters and items to respond to their environment, for example reacting when a user approaches, or knowing which way to point to send the user to the next location in the journey.
d) Developers may refer to map locations by defining map descriptors, a named script element that can incorporate specific map coordinates, real-time location information of users, AR characters, and AR items, and map metadata.
e) Map routes would be computed using a depth-first directed search that avoided “no go” map locations as marked by metadata, and took into account the mode of travel (walking, running, bicycle, car, public transit).
f) Users who wish to communicate with remote users, or to be matched with other users in real time or at a scheduled time, or who wish to exchange items, may do so through an anonymizing server that hides the true IPs of the users, and shows only the public portion of each users' profile.
g) Metrics would include a log of user interactivity with AR items, AR characters, and other users, user GPS logging, usage statistics such as time and money spent with an app, download and active installation statistics, and the demographics of users.

### BRIEF DESCRIPTION OF THE DRAWINGS

The foregoing and other features, and advantages will be apparent from the following more particular description of preferred embodiments, as illustrated in the accompanying drawings in which like reference characters refer to the same parts throughout the different views.

FIG. 1 shows the high-level architecture of an AR experience platform

FIG. 2 shows how an app is constructed from content and scripting

FIG. 3 gives examples of map, AR object, and user descriptors for scripting

FIG. 4 gives an example of a script

FIG. 5 shows an architecture for multiple apps in an integrated AR world

FIG. 6 shows an example AR Experience App listing in the app store

FIG. 7 shows an example of metrics that could be computed and displayed

FIG. 8 is an example data schema for storing system information.

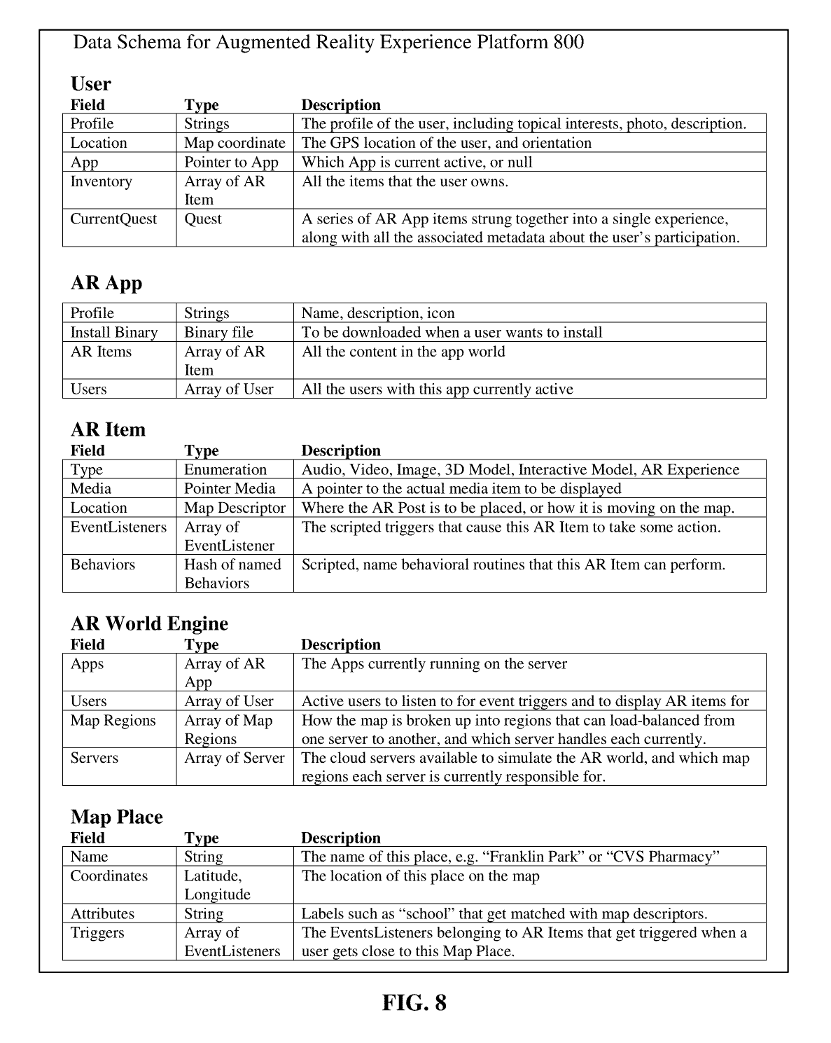

### DETAILED DESCRIPTION

A description of preferred embodiments follows.

### AR App Architecture

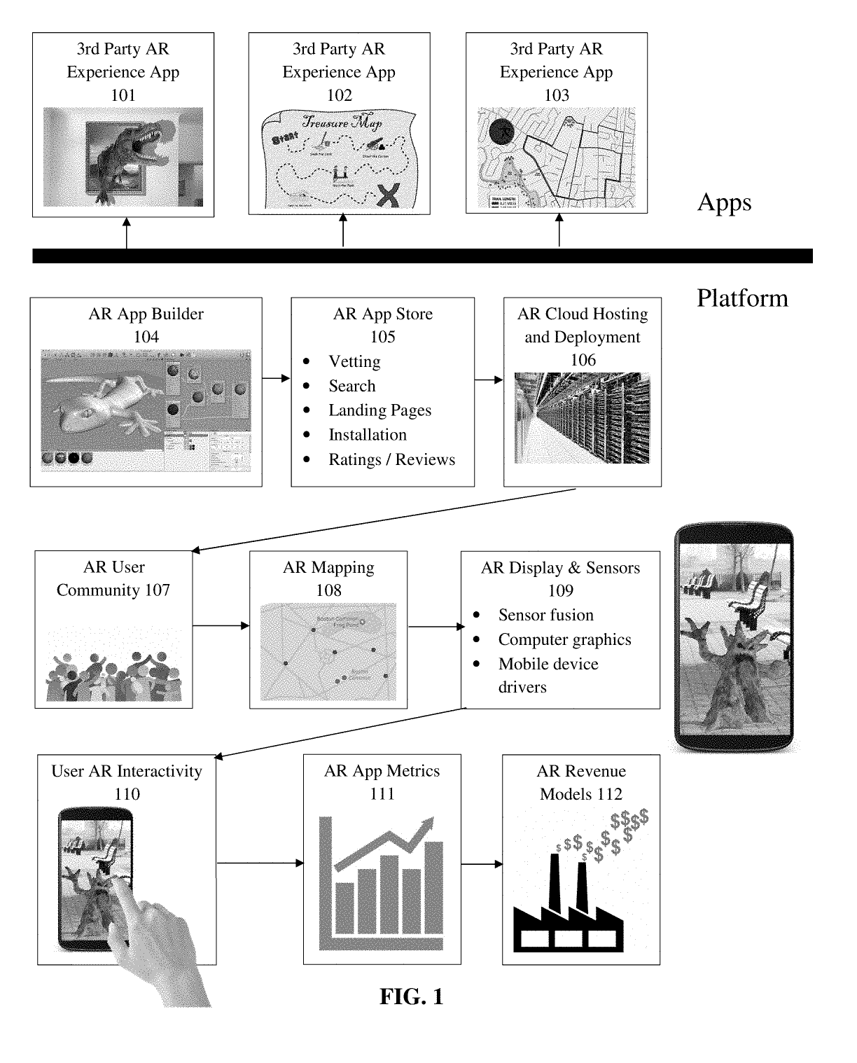

FIG. 1 shows the high-level architecture of an AR experience platform. Below the line are the individual modules which make up the platform.

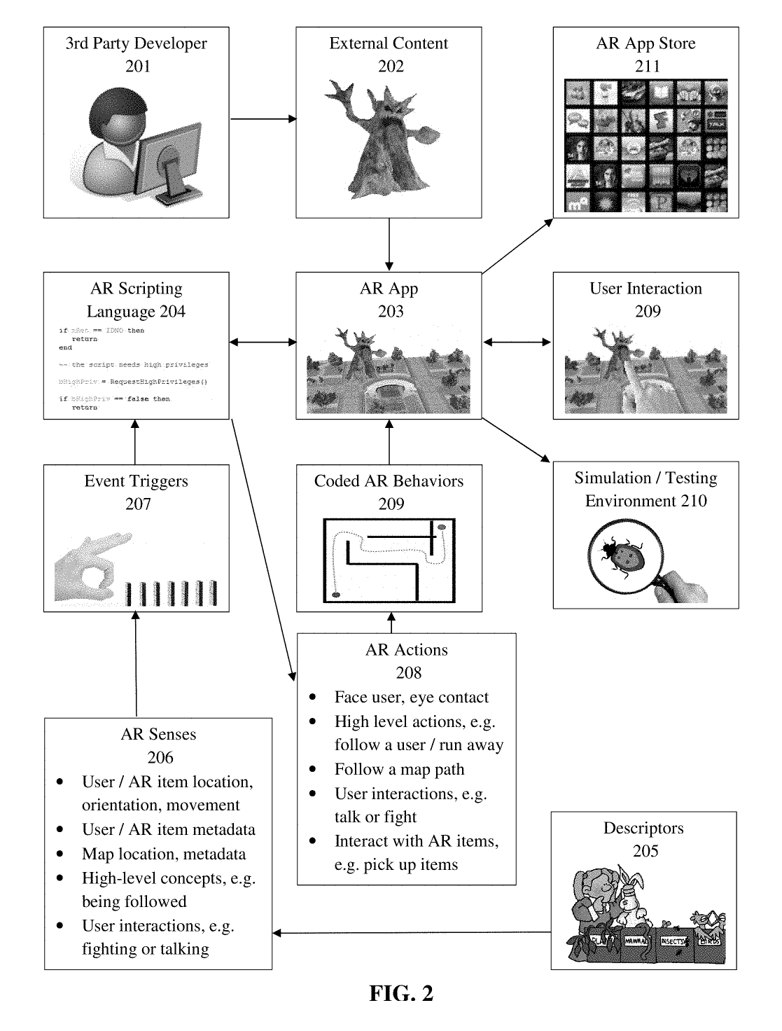

Each is specially suited to an AR development environment. To start with, a third party app developer uses the AR App Builder 104 to import content such as a 3D model and then to make it AR responsive as in FIG. 2 by:
Giving it a specific map location, series of locations, or route to traverse.
Defining its responses to the world and the behaviors it can perform.

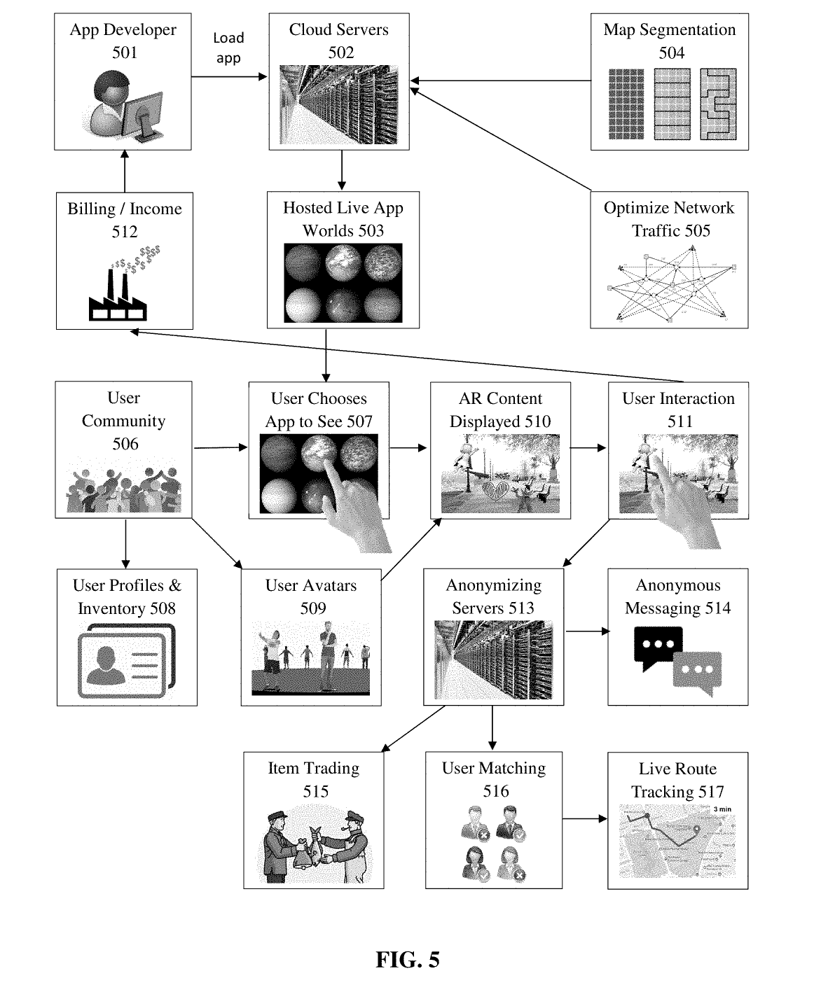

Once the AR app has been created, it is submitted to an AR App Store 105 for possible vetting and for display. From there, a Cloud Hosted Environment 106 allows users to download and install an app, as in FIG. 5. Also as in FIG. 5, the Cloud Hosted Environment 106 simulates the AR world and mediates the user's interactions with it.

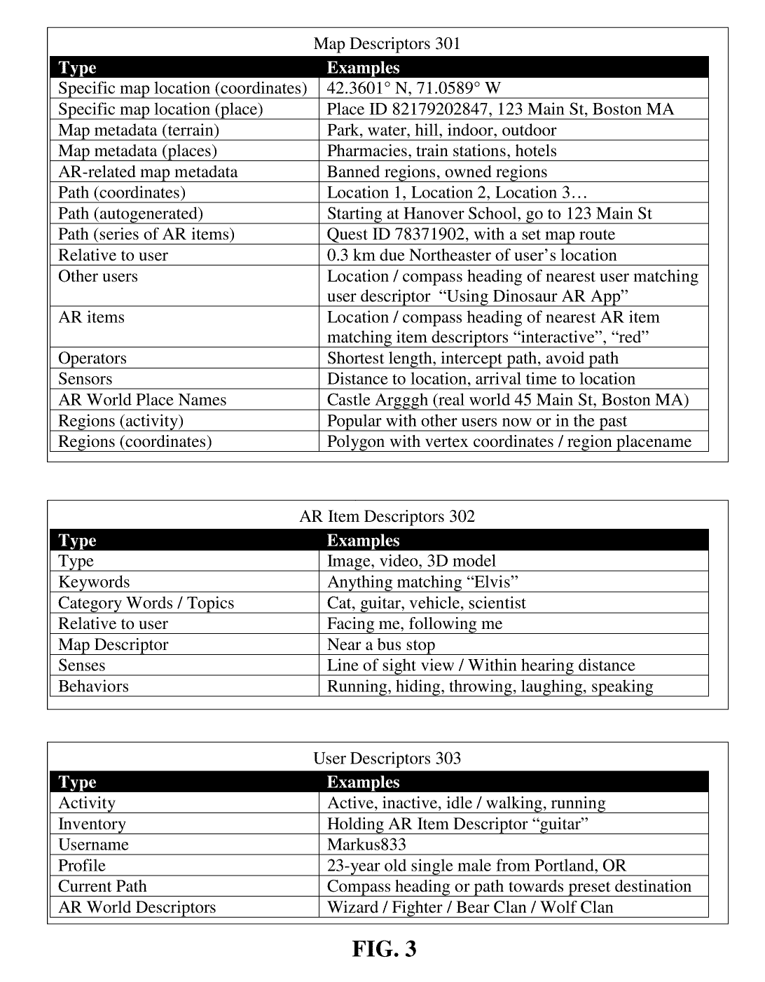

Users are part of an AR User Community 107 which can message each other, trade items, or meet in the real world. This makes extensive use of AR Mapping 108, where virtual AR items are placed at map locations in the real world. Complicated routes may be calculated for AR items, and sets of AR items may be distributed along a pathway or randomly inside a map region, as in FIG. 3.

Users see these AR items through the AR Display & Sensors 109 on their mobile phones, which is not part of the this invention but supplied by a third party and integrated into the system. The AR Display & Sensors 109 also track the position of the phone so that AR items can be drawn in the correct locations.

Although each app will have its own specific AR item interactions, the platform provides for some of the most common User AR Interactivity 110, such as clicking on an AR item to see a description of the potential experience should the user wish to engage. The platform also allows users to pick up an AR item into the user's inventory, and to place items down from the user's inventory.

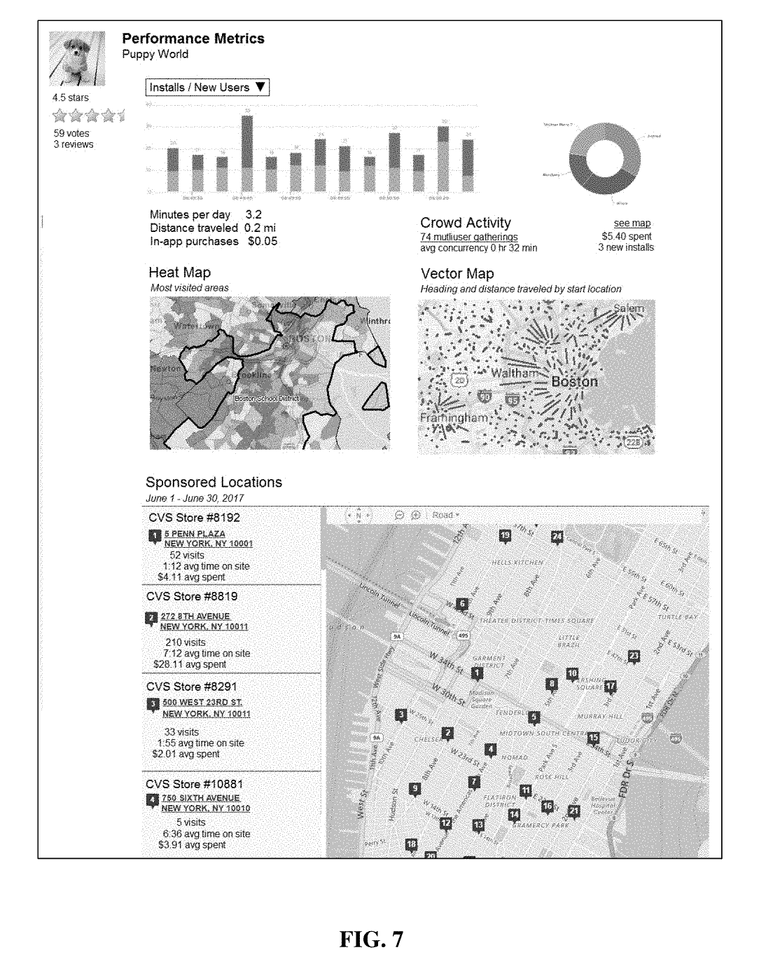

App developers will naturally wish to track AR App Metrics 111 about how their AR App is performing. They could for example track activity of users, AR Items, especially as user's install the app and spend money, as show in FIG. 7. Finally, the platform allows users to pay or get paid for AR experiences, with AR Revenue Models 112 built into the platform's scripting language, including a system for billing and payments.

### Building an AR App

FIG. 2 shows how a 3rd Party Developer 201 can construct an AR app 203.

The 3rd party developer does not use the platform for generic tasks such as creating 3D models, images, video, audio, and other forms of media that can become AR items. Instead, External Content 202 is made elsewhere and loaded into the AR App 203. In this loading, AR Items are placed into the environment at real world map locations, either statically or algorithmically using Map Descriptors 301.

The AR Items are then associated with scripts in an AR Scripting Language 204, either individually or by object-oriented class type, that give each AR Item a relationship with its virtual environment (other AR Items), real-world environment (maps), and users, including user behavior.

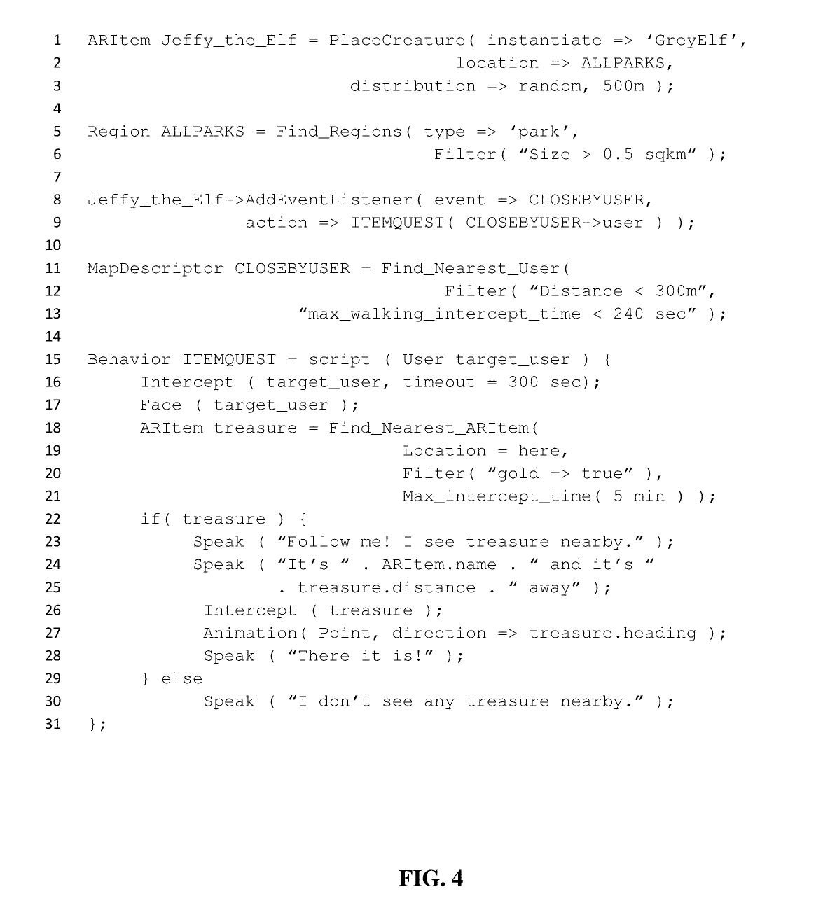

The AR Scripting Language 204 include Event Triggers 207, which are snippets of code, as shown in FIG. 4, that only get called when something in the environment changes. These changes may be compiled from Descriptors 205 that refer to map locations, AR Items, and Users by their attributes, as show in

FIG. 3. These low-level descriptors are then combined into high-level AR Senses 206 that give AR Items an ability to respond to the AR world and real world (through its known map) around them. For example:
A user may come within sensing range of the AR Item, which could trigger the AR Item to run away.
A user may offer to trade, talk, or otherwise interact with an AR

Item
A nearby AR Item could change its position, or change its nature (a pile of wood starts to burn).
The AR Item while moving comes to a street corner and must decide which way to turn.
The AR Item while moving approaches a location with special significance on the map, such as a park or school grounds.
The AR Item has no line of sight, or a fresh line of sight, to another AR Item or user.

Sensory elements can be combined into high-level sensory algorithms. For example, a user's position and speed could be used in a new algorithm that senses whether an AR Item in motion is being followed by the user.

Once the AR Senses 206 active an Event Trigger 207, an associated snippet of code in the AR Scripting Language 204 is executed, which may result in an AR Action 208 being performed. The platform could come with several item actions that have an augmented reality context, such as an AR Item:
Turning to face a user,
Running towards a map place such as the closest school
Pointing towards a map feature such as a street corner
Aiming a gun towards another AR Item
Traversing a map route from place to place

The AR Actions 208 become building blocks for high-level Coded AR Behaviors 209, which affect what happens in the AR world in the AR App 203. This would typically involve User Interaction 209, but the AR Items can also simply interact with each other and map features, or interact with simulated users as part of a Simulation/Testing Environment 210.

After development and testing, the 3rd Party Developer 201 uploads the AR App 203 into an AR App Store 211 for users to discover, consider, and potentially download, install, and use.

Descriptors are Hooks for Scripted AR Interactivity

FIG. 3 lists how map locations, users, and AR items can be referred to in scripting. For example, a specific place on the map could be referred to:
By its map coordinates (latitude and longitude),
By its address
By the name of some geographic place (“Hyde Park”),
By the name of some organization on the map (“Walmart”), possibly combined with an address for clarity,
With a place attribute and map operators, such as:
   The nearest organization with name matching Walmart,
   A geographic feature with attribute “park” between 0.3 and 1 mile away,
   An organization with attribute “pharmacy” with a plotted map route time to arrive between 3 minutes and 10 minutes,
   The closest school at a Northeast heading,
Or in relation to AR Items and users, such as:
   The closest user that is not more than 10 minutes transit away
   The nearest AR Item with attribute “gold”

Instead of a pinpoint on a map, scripts may also refer to compass headings, paths and regions, for example:
Define a route from the user's current location to 123 Main Street, Boston, Mass.,
Create a region defined by a polygon enclosing 6 map points,
Select the region defined by the map attribute “Franklin Park”
Create a path from the user's route in the last 10 minutes

Items may be laid out along paths or across regions, for example:
Place the Munchkins, Scarecrow, Tin Man, Lion, and Wizard along a given path at regular intervals of transit time 3 minutes,
Instantiate AR Items of type “sunflower” randomly across the region “Boston Common”, with distribution parameters specifying a target density of one sunflower every 20 square meters,
Instantiate AR Items of type “gravestone” in a grid pattern with compass heading North and distribution distance 3 meters×2 meters over the region “Sand Hill Park”,

Finally, points, paths, and regions may be used to perform database queries for users and AR Items, for example:
Query the database for all AR Items with attribute “animal” in region “Forest Hills Dog Park”
Find a café that is not more than 5 minutes out of the way along a path from the user's location and 123 Main Street, Boston, Mass.
Trigger an EventListener if an AR Item of type “squirrel” enters region “Forest Hills Dog Park”

### An Example AR App Script

FIG. 4 is an example script for automated AR item simulation.

Videogames and other kinds of simulations have used behavioral scripts for ages, but an AR App Script is novel because of its real-time awareness of the user (e.g. map position, motion of the phone), map information, and placement of AR items into real world locations.

In this behavioral script, a set ARItem creatures are created on line 1 called Jeffy_the_Elf. The creature is instantiated from a class of ARItem called GreyElf, which is defined elsewhere. These instantiations are distributed randomly (but spread out 500 meters) through every map region in the world that matches the query ALLPARKS.

ALLPARKS is defined on line 5 to be every outdoor space that is at least 0.5 square kilometer. So copies of Jeffy_the_Elf would pop up across every park space in the world that isn't tiny.

Then on line 8 we attach an Event Listener to the set of AR Items in Jeffy_The_Elf. The Event Listener waits until something changes in the world, CLOSEBYUSER, and then activates function ITEMQUEST, passing in the detected user as a parameter to the function.

CLOSEBYUSER is defined on line 11 to be any user within 300 meters that the ARItem can transit to within 240 seconds at a walking speed.

Any instantiation of Jeffy_The_Elf that gets triggered will executive the behavioral script at line 15, ITEMQUEST.

On line 16, the ARItem attempts to intercept the user by walking to the user's location. Of course, the user's location may be changing in real-time, and the AR Item will give up attempting to intercept in 300 seconds, which could happen for example if the user is running away from the ARItem.

On line 17, the ARItem turns to face the user. On line 18, the ARItem searches for a nearby treasure, a database query that returns the closest ARItem with attribute “gold” that can be walked to within 5 minutes, according to map pathways.

On line 22, if a nearby item was found, Jeffy_The_Elf tells the user, “Follow me!” (lines 23, 24) and then walks to the item (line 26). Presumably the treasure is not moving, so the intercept is straightforward. Jeffy then executes a pointing animation on line 27, pointing to the treasure, and tells the user where it is.

Of course, this script omits several complications, such as:
What Jeffy is supposed to do if he can't intercept the user,
What happens if the user doesn't follow Jeffy,
Whether Jeffy is aware of obstacles such as street crossings, and slows down if the user must wait for traffic,
What happens if the treasure is picked up by some other user,
Whether Jeffy will follow the treasure infinitely if it's in motion,
What happens if Jeffy and the user, en route to the treasure, pass within hailing distance of some other instantiation of Jeffy, who also gets triggered, and
Whether the user can refuse Jeffy's invitation, triggering all other Jeffy instantiations to ignore the user instead of making a fresh offer.

One could also imagine an adventure where Jeffy, instead of leading the user to the treasure, gave directions verbally to the user, or spoke about the treasure's location through autogenerated clues such as “It's just to the south of the nearest pharmacy whose name starts with ‘R’. Good luck!”

### Cloud Architecture for Hosting Live AR Apps

FIG. 5 shows how a cloud server may host several live apps.

The App Developer 501 loads the app, including its scripts and items, into the platform's Cloud Servers 502, so that they become Hosted Live App Worlds 503 whose scripts are executing, taking information from real-world inputs such as user locations, and rendering AR items at real-world locations.

The map of the entire world is segmented 504 into computing regions. Each server in the array of Cloud Servers 502 is responsible for responding to user behavior and simulating AR items across a set of specific computing regions. Special algorithms will try to keep each server's set of computing regions contiguous, so that users and AR items that transition from one computing region to a neighboring computing region won't always need to be sent to a different server.

Algorithms also Optimize Network Traffic 505, for example, reducing communication delays by assigning computing regions to Cloud Servers 502 that are physically housed in a server farm close to the computing region. Servers in Japan should not be responsible for computing regions in Scotland.

Network traffic must also be optimized for bandwidth, as users may have mobile devices without healthy Internet connections. For example, 3D models with reduced quality (but also reduced size) may be sent to users, and content may be preloaded to the user. Some types of behavior script execution may even be delegated client-side to the user's mobile device, so that responses can be instant without any Internet delay. Scripts delegated to a user client device, which may be hacked, could perhaps be fact-checked later by a redundant behavioral script execution on the server side.

The platform has a shared User Community 506, where users have User Profiles 508 and an inventory for holding AR Items 508. Users may also have User Avatars 509 that represent the user in the world. For example, when an

AR Item wishes to fight, it would be facing and fighting the user's avatar, not facing the user's mobile device camera.

Users from the User Community 506 can pick and choose which apps they wish to run 507. AR Content is Displayed 510 to a user from whichever app or apps he or she is running. The user may of course interact 511 with AR Items.

Two users who are physically collocated may of course speak to each other in the real world without any intermediary. However, users who are not collocated will want to interact through Anonymizing Servers 513. These disguise the user's IP addresses of origin, making it possible for two users to engage with each other safely without giving up each other's true IP address. Through the Anonymizing Servers 513, a user may for example:
Exchange Anonymous Messages 514 with another user,
Give an AR Item 515 from the user's inventory to another user,
Take an item from another user, or
Request to be matched with another user 516.

Users who get matched together may be given map routes to a designated meeting location, and then see each other's GPS position live 517, in real-time, to reduce anxiety about whether the other person is really coming, and to reduce confusion about how to physically meet.

### An Example AR App Store Listing

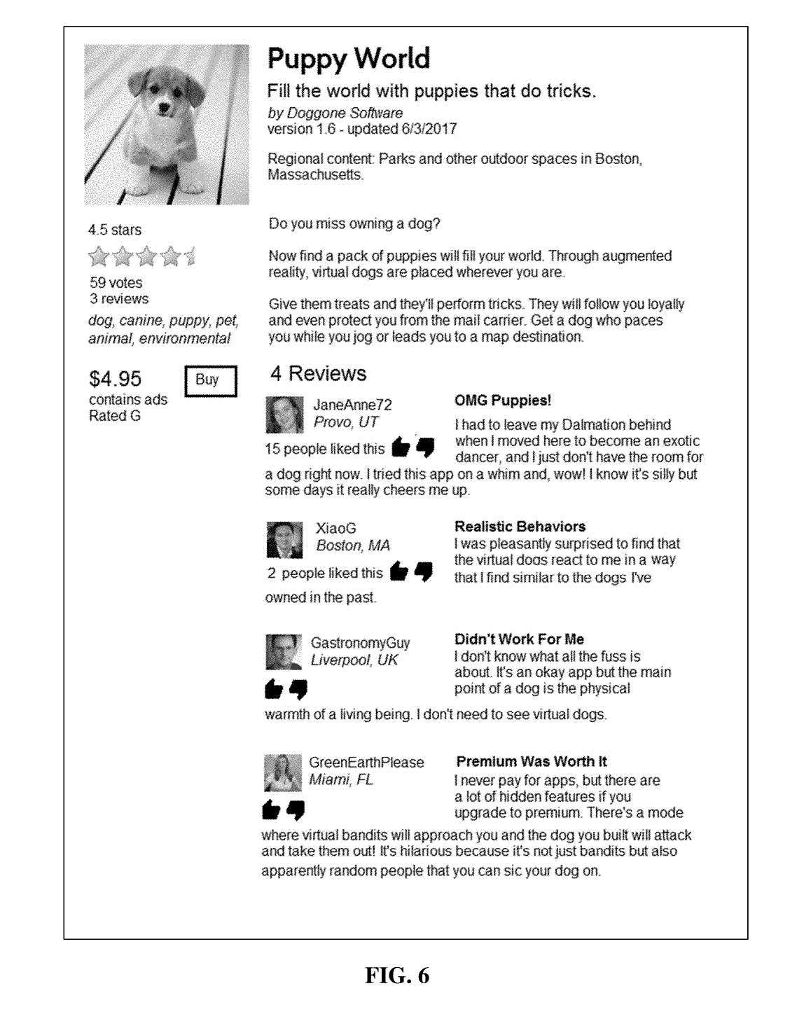

FIG. 6 is an example of an app listing in the app store. It presents:
A name, tagline, photo, description, version number, version update time, and the name of the app's maker,
The map regions where this AR app is active,
Real world restrictions to using the app, such as to the speed that users travel or where the app may be used,
Ratings and reviews,
Topical tags,
A cost and button to download.

Users may be able to discover AR Apps by the AR Items are placed in a selected map region. For example, when visiting the Statue of Liberty, a user could see on his or her map the apps that are hosting AR Item content in the vicinity. Users may be forbidden from using the app in certain real-world environments, for example at night, over the water, or while driving. Users may be warned that the app requires users to run, to be able to hear, or to enter areas that may not be handicapped accessible.

### An Example of AR App Analytics

FIG. 7 is an example analytics report on the metrics of an app, including:
The name and image of the AR App
Statistics on how many users have installed the app, or actively use it,
Statistics on what types of mobile devices are used with the app,
A heat map showing where users most frequently use the app
A vector map showing where users most frequently are traveling to when they use the app.
Performance statistics on locations, which may include:
   How frequently users visited the location
   How long they stayed for
   Whether they performed certain actions there
   How much money they made or spent, which may be important for example if a sponsor has paid to draw users to a location

What is claimed is:

1. A method that permits third party apps to run in a single, persistent augmented reality environment, comprising:
an app store to which developers can submit an app;
a process for users to search the store for apps, for example via map region or real-time activity, and then to install their choices; and
execution of the app through an augmented reality platform on the user's mobile device.

2. A method as in claim 1 further comprising:
an AR-specific content builder;
a scripting language for AR item and character behavior; and
a system to execute such scripts.

3. A method as in claim 2 further comprising:
a system of event listeners trigged by environmental factors.

4. A method as in claim 2 further compromising:
a system of event listeners trigged by user interactivity.

5. A method as in claim 3 further comprising:
a way to define map “descriptors” for use in scripted behaviors or sensors;
a system for updating map descriptors in real time.

6. A method as in claim 5 further comprising:
a way to calculate map routes between given descriptors.

7. A method as in claim 1 further comprising:
an anonymizing server to permit anonymous user communication.

8. A method as in claim 7 further comprising:
a system to match users together and set up real world meetings.

9. A method as in claim 2 further comprising:
an extension to the scripting system to allow users to pay or be paid.

10. A method as in claim 1 further comprising:
a way for the user community to submit ratings, reviews, or abuse flags to an AR experience app.

11. A method as in claim 1 further comprising:
automatically computed metrics, which may include:
logging of user behavior in specific map regions;
statistics on user visits to specific locations; and
map features such as traffic crosswalks interfering with apps.

12. A method as in claim 1 further comprising:
a system to partition and load balance AR experience app computations across several servers.

13. A method as in claim 1 further comprising:
a system to support user avatars shown in the AR view and controlled by users by physically walking or by physically moving their mobile device.

14. A method as in claim 1 further comprising:
a system to support the ownership of AR items by users.

15. A method as in claim 1 further comprising:
a simulated AR environment for testing.
